(19) United States
(12) Patent Application Publication
(10) Pub. No.: US 2010/0103064 A1
(43) Pub. Date: Apr. 29, 2010

(54) PARASITIC DIPOLE ASSISTED WLAN ANTENNA

(75) Inventors: Guangli Yang, Middle Island, NY (US); Xiaotao Liang, Dix Hills, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/256,627

(22) Filed: Oct. 23, 2008

(51) Int. Cl. H01Q 9/16

(52) U.S. Cl. 343/793; 29/600

(57) ABSTRACT

A parasitic dipole assisted WLAN antenna for creating a second resonance in the A band and providing greater bandwidth usage to a mobile computing or communication device. A secondary B/G band monopole antenna is connected to the A band antenna at the point of maximum impedance of the A band providing minimal interference between the two bands. The dipole structure antennas are connected at the A band loop antenna feed pin and ground pin.

### TECHNICAL FIELD

The subject invention relates generally to portable computers and communication devices, and more particularly to antennas attached to circuit boards for allowing transmission to and reception from a wireless local area network.

### BACKGROUND

Computing and communication devices such as handheld computers and cellular telephones are have become a necessary tool for today's worker and are carried by almost every member of modern society. The utility of the device has led to greater use of the device and a corresponding explosion in the number of applications has occurred, including applications requiring connectivity to the internet and other communications networks. The greater utilization of applications requiring connectivity to other networks and devices has increased the bandwidth requirements of the devices and exceeded the ability of the devices to perform at the level expected by the consumer.

Many of today's computing and communication devices also require connectivity to multiple networks operating at different frequencies. This trend requires the use of multiple antennas designed and tuned to effectively transmit and receive at each frequency. The combination of a requirement for multiple antennas and the desire to make a smaller device for the consumer has led to market pressure for antennas that provide greater bandwidth while maintaining the same physical footprint.

The necessity of incorporating multiple antennas into close proximity has also created problems relating to the interconnection of the antennas. Physical real estate on the printed circuit boards has become harder to provide requiring the interconnection of antennas where practical. It is sometimes difficult and counterproductive to interconnect antennas for different frequencies because the antennas will interfere with each other if they are not connected at the appropriate location.

Market demand has created the requirement for smaller computing and communication devices with antennas interconnected to preserve space on the printed circuit board while providing sufficient bandwidth to allow the user to communicate over the selected network at the performance level expected by the user. In some instances, the antenna system must replace a currently existing antenna system while providing better performance without requiring any additional space on the printed circuit board.

### SUMMARY

The following presents a simplified summary in order to provide a basic understanding of some aspects described herein. This summary is neither an extensive overview nor is intended to identify key/critical elements or to delineate the scope of the various aspects described herein. Its sole purpose is to present some concepts in a simplified form as a prelude to the more detailed description presented later.

The subject innovation includes a one wavelength loop shaped in a rectangular structure and connected on one end to the feed pin and on the other end to the ground pin. The rectangular loop produces a resonance at the frequency of interest. A second one half wavelength resonance is produced by including a parasitic dipole structure joined to the loop structure at the top of the feed pin and ground pin respectively.

In another aspect of the subject innovation, another resonance form a separate antenna branch for different frequency is attached to the loop structure at the point on the loop structure where it is high impedance of the loop resonance. Because the loop resonant frequency is two times higher than this different frequency, the connection point has low impedance at the resonance of the separate antenna. Locating the connection between the two antennas at this point assures minimum impact between the separate antenna and the loop structure.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates an embodiment of the components of a parasitic dipole assisted WLAN antenna, including the printed circuit board, the one wavelength loop structure, the one-half wavelength dipole structure and the one-quarter wavelength secondary frequency monopole structure.

FIG. 2 illustrates an embodiment of the components of a parasitic dipole assisted WLAN antenna including the connection between the one wavelength loop structure and the one-quarter wavelength monopole structure at the high impedance point of resonance from one wavelength loop structure.

FIG. 3 illustrates an embodiment of the components of a parasitic dipole assisted WLAN antenna including the non-conductive mounting block supporting the one wavelength loop structure, the dipole structure and the one-quarter wavelength secondary frequency monopole structure mounted on a perpendicular face of the mounting block.

FIG. 4 illustrates an embodiment of a parasitic dipole assisted WLAN antenna displaying the H field strength of the loop and dipole structure at A band along the antenna.

FIG. 5 illustrates an embodiment of a parasitic dipole assisted WLAN antenna displaying the H field strength of the loop, dipole structure and one-quarter wavelength secondary frequency monopole structure at B/G band along the antenna.

FIG. 6 illustrates the entire bandwidth provided by the combination one wavelength loop structure and the one-half wavelength dipole structure.

FIG. 7 illustrates the improvement in bandwidth coverage provided by the parasitic dipole assisted WLAN antenna with respect to existing antenna capabilities.

FIG. 8 illustrates the parasitic dipole assisted WLAN antenna mounted on a typical mobile computing device.

FIG. 9 illustrates a method for determining the correct position to attach the one-quarter wavelength secondary frequency monopole structure to the one wavelength loop structure.

### DETAILED DESCRIPTION

Systems and methods are provided enabling the attachment of a parasitic dipole assisted WLAN antenna to a mobile computing device or a mobile communication device. The design and assembly of the parasitic dipole assisted WLAN antenna provides for an additional resonance in the A band frequency and accordingly improves the bandwidth allowing the use of applications requiring greater bandwidth than that provided by a single resonance antenna. The parasitic dipole assisted WLAN antenna also provides attachment of a B/G band monopole antenna connected at a point of maximum impedance of the A band, therefore allowing support for the reception of the different bands while incurring minimum interference between the bands. It should be noted that although this innovation is illustrated with WLAN A and B/G band applications, it is not limited therewith. This innovation is applicable to scaling of the geometry to allow for other frequencies for additional dual-band or tri-band applications.

In one aspect of the subject disclosure, the parasitic dipole assisted WLAN antenna is mounted on a plastic block support structure allowing for placement of the dipole assisted A band loop antenna on one face of the plastic mounting block and the B/G band monopole antenna on a perpendicular face of the plastic mounting block. For example, the A band parasitic dipole assisted WLAN loop antenna is mounted on the face of the plastic block parallel to and away from the printed circuit board and the B/G band monopole antenna is mounted on the long dimension face of the plastic block perpendicular to the printed circuit board and on the opposite side of the plastic block from the feed and ground pin connectors. It should be noted that the mounting block can be constructed of any non-conductive material. It should also be noted that depending on the available space on the printed circuit board, the B/G band monopole antenna can be mounted in the same plane as the A band loop antenna and in some embodiments does not require a mounting block and can be mounted directly to a printed circuit board.

It should be noted that although useful for describing the invention, the subject innovation is not limited to mobile computing or mobile communication devices. The parasitic dipole assisted WLAN antenna is equally applicable to any computing device, mobile or stationary. It should also be noted that although useful for describing the subject invention, the parasitic dipole assisted WLAN antenna is not limited to internal installation in a device, the parasitic dipole assisted WLAN antenna can be connected as an external antenna.

As used herein, the term to “infer” or “inference” refer generally to the process of reasoning about or inferring states of the system, environment, user, and/or intent from a set of observations as captured via events and/or data. Captured data and events can include user data, device data, environment data, implicit and explicit data, etc. Inference can be employed to identify a specific context or action, or can generate a probability distribution over states, for example. The inference can be probabilistic, that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

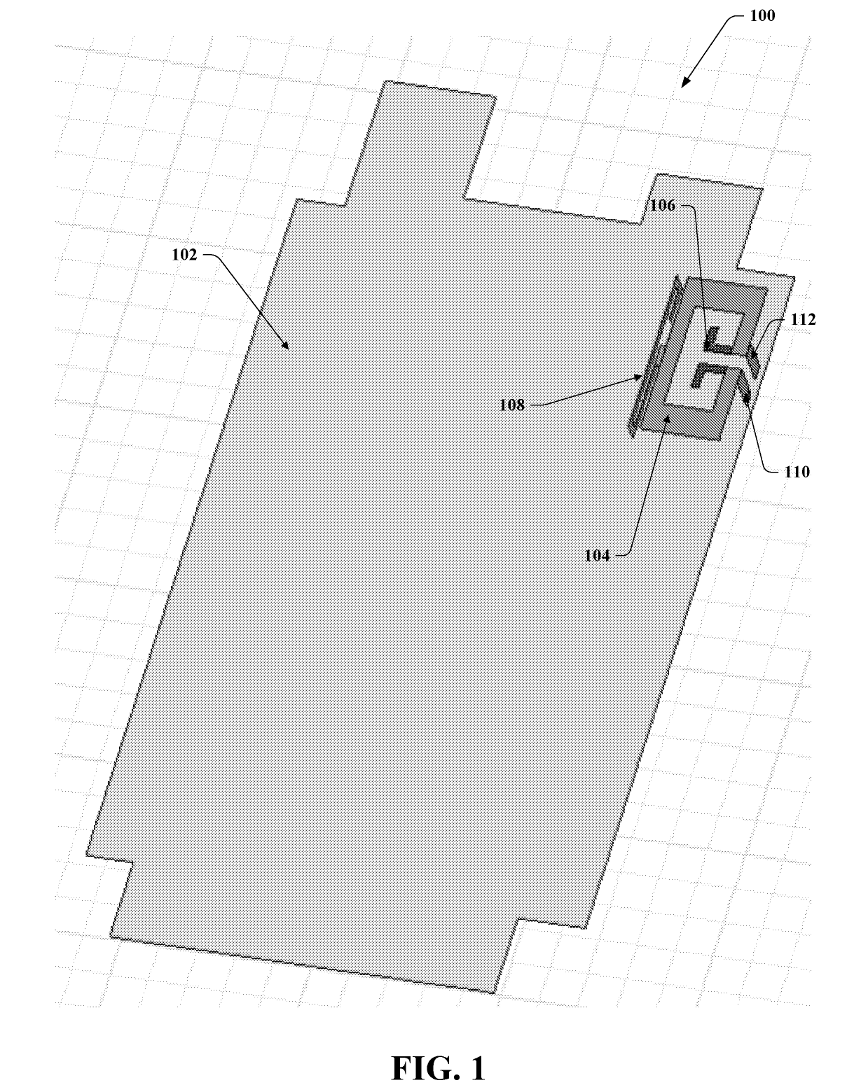

Referring initially to FIG. 1, a view of the printed circuit board 102 of a mobile computing device or a mobile communication device with a parasitic dipole assisted WLAN antenna 100 is represented. The parasitic dipole assisted WLAN antenna comprises an A band one wavelength loop antenna 104, two one-quarter wavelength dipole antenna elements 106, one connected at the feed pin 110 and one connected at the ground pin 112 and a one quarter wavelength B/G band monopole antenna 108, connected to the A band one wavelength loop antenna.

In one aspect of the subject innovation, the parasitic dipole assisted WLAN antenna 100 is a planar structure mounted on top of a ground plane, the printed circuit board 102 is the ground plane in this example. The parasitic dipole assisted WLAN antenna 100 consists of three parts, two parts for the A band 104, 106 and one part for the B/G band 108 in addition to a feed pin 110 and a ground pin 112. With regard to the A band, one resonance is created from the one wavelength loop structure 104 and another is created from the one-half wavelength dipole structure 106. It should be noted that the dipole structure is a combination of two one-quarter wavelength antenna elements summing to a one-half wavelength dipole. With regard to the B/G band, a resonance is created from the one-quarter wavelength monopole structure 108 connected to the A band one-wavelength loop structure 104.

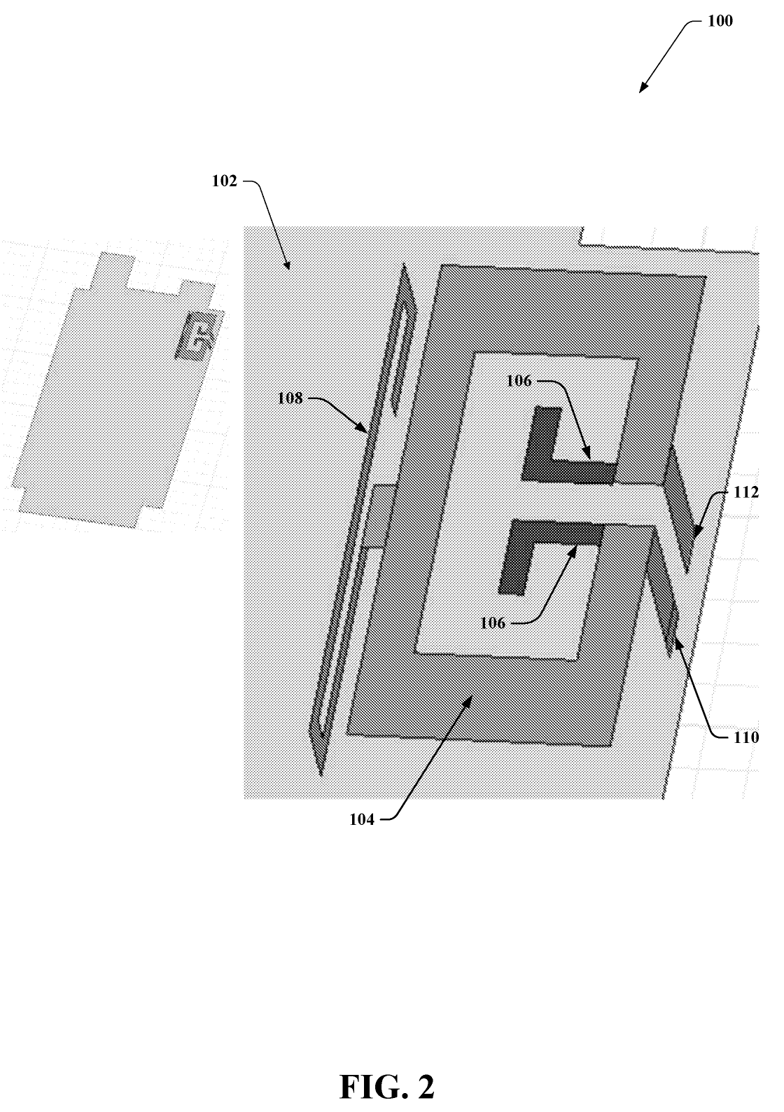

Referring next to FIG. 2, a close-up of the parasitic dipole assisted WLAN antenna 100 is represented without the plastic mounting block. In one aspect of the subject innovation, the A band one-wavelength loop 104 is connected to the B/G band one-quarter wavelength monopole 108 at a point on the A band one-wavelength loop 104 where the impedance of the A band is at a maximum. In another aspect of the subject innovation, the parasitic dipole antenna 106 is connected to the A band one-wavelength loop antenna 104 at the locations where the A band one-wavelength loop antenna 104 is connected to the feed pin 110 and to the ground pin 112.

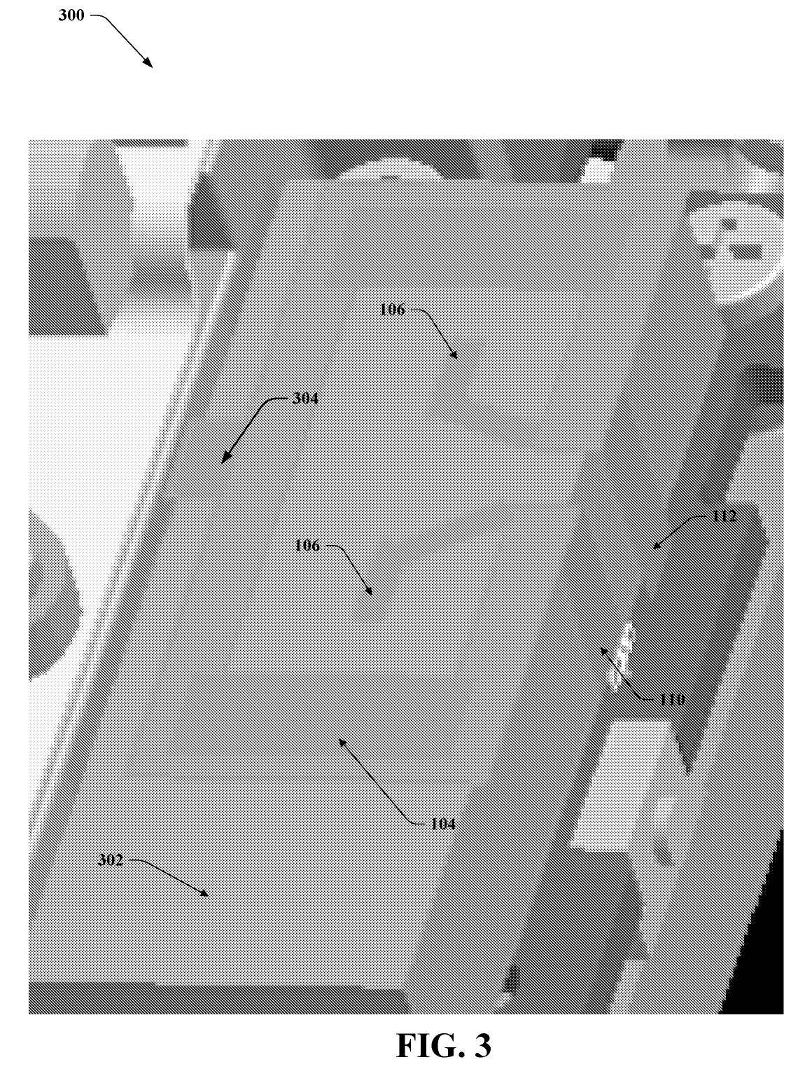

Referring now to FIG. 3, a view of the parasitic dipole assisted WLAN antenna is represented attached to the plastic mounting block 302. The A band one-wavelength loop antenna 104, including the two one-quarter wavelength dipole antenna elements 106 are illustrated on one face of the plastic mounting block 302. On one of the long faces of the plastic mounting block 302 perpendicular to the face where the A band one-wavelength loop antenna 104 is located, is the feed pin 110 and the ground pin 112 connectors, attached to the printed circuit board 102. On the opposite long face of the plastic mounting block 302 from the feed pin 110 and the ground pin 112 is the B/G band one-quarter wavelength monopole antenna 108 connected to the A band one-wavelength loop antenna 104 at the point on the loop where the impedance of the A band is at a maximum 304. It should be noted that the mounting block used in this innovation can be manufactured of any non-conductive material.

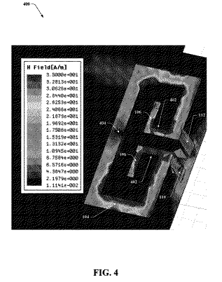

Referring now to FIG. 4, a heat map type graph 400 representing the H field strength of the band (A band) associated with the parasitic dipole assisted WLAN loop antenna is presented. The H field strength heat map graph shows the high field strength located around the parasitic dipoles 402, indicating the cumulative increase in the signal strength based on the combined use of the A band one-wavelength loop antenna 104 and the two one-quarter wavelength dipole antenna elements 106. In another aspect of the H field strength heat map 500 illustrated at 404, the field strength of the A band at this point is at a minimum and therefore indicates the location where the B/G band one-half wavelength monopole antenna 108 will be attached to the A band one-wavelength loop antenna 104.

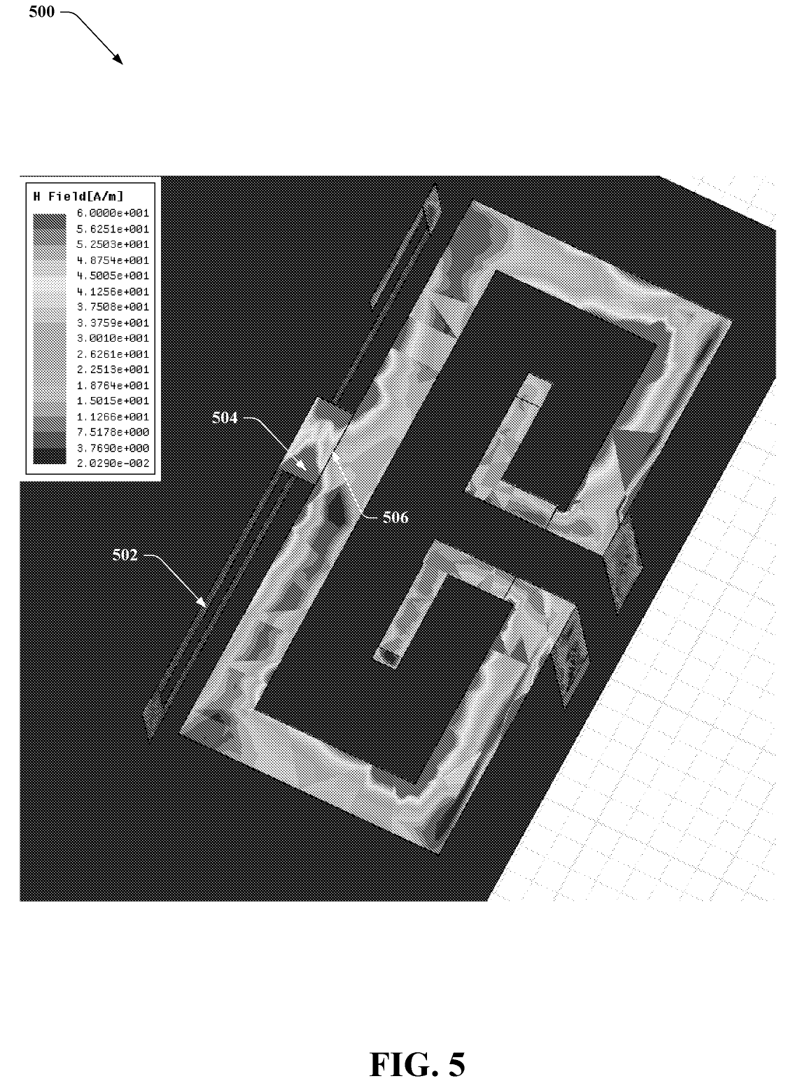

Referring next to FIG. 5, another heat map type graph 500 representing the H field strength at B/G band is presented. The heat map graph illustrates the H field strength of the band associated with the monopole antenna. For example, the B/G band one-quarter wavelength monopole antenna 502. The H field strength heat map graph shows the high field strength, or current flow, from the first band loop antenna to the second band monopole antenna 504. As a result of the high impedance at the resonance of the first band antenna and the low impedance at the resonance of the second band antenna at the connection point 506 of the two antennas, a minimum impact and amount of interference between the loop antenna and the monopole antenna is assured.

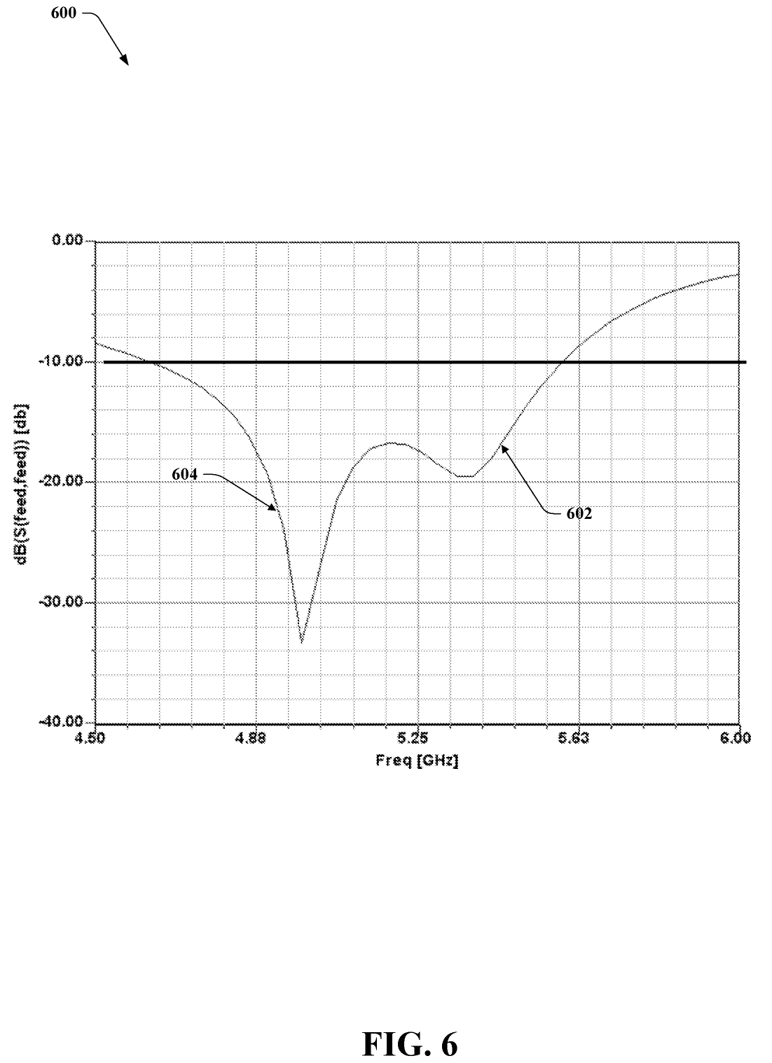

Referring now to FIG. 6, a signal strength graph 600 plotting the A band signal strength against the frequency is represented. In one aspect of the subject innovation, the graph has two inverted peaks 602 and 604. Peak 602 of the signal strength graph 600 represents the signal strength provided by the A band one-wavelength loop antenna. Peak 604 of the signal strength graph 600 represents the signal strength provided by the two A band one-quarter wavelength dipole antennas. As illustrated by the graph, the bandwidth of the subject innovation is significantly wider than the bandwidth provided by the A band one-wavelength antenna.

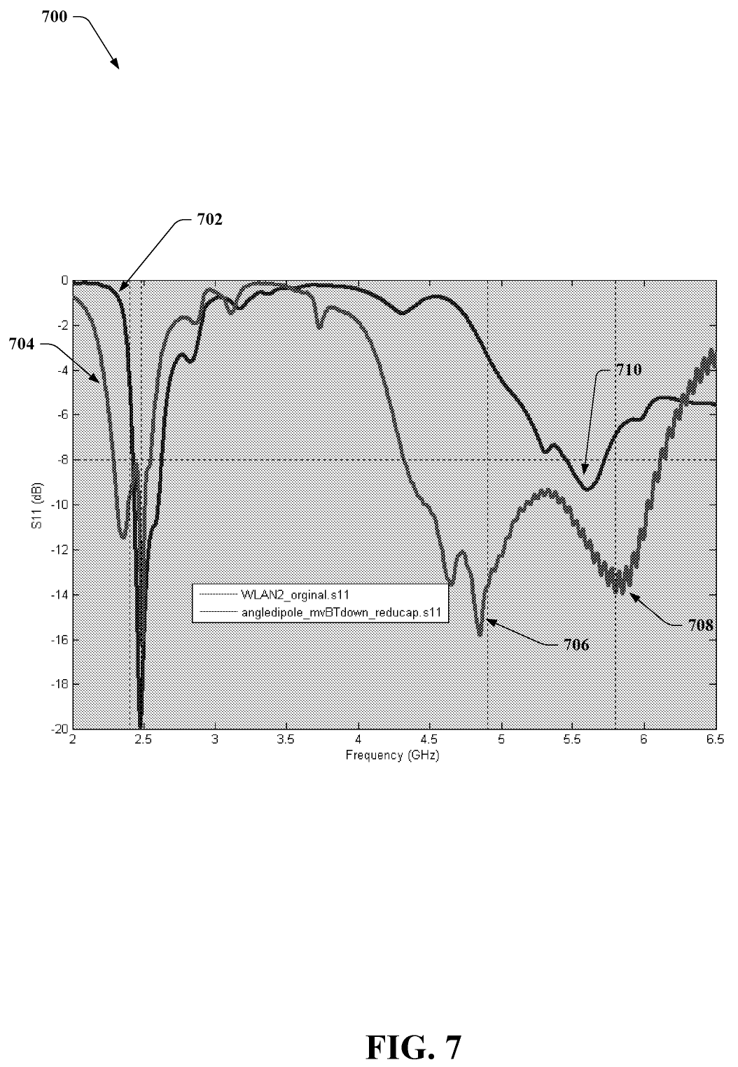

Referring next to FIG. 7, a signal strength graph 700 plotting the A band and the B/G band of the subject innovation compared to a presently available antenna covering the same bands is represented. In one aspect of the subject innovation illustrated at 702, the B/G band signal strength of the currently available antenna is represented. When compared with the B/G band signal strength of the subject innovation, it is clear that the two antennas have similar and acceptable coverage of the B/G band frequency.

In another aspect of the subject innovation, the A band coverage of the currently available antenna is represented by the graph with the A band peak at 710. The subject innovation A band peaks, located at 708 for the one-wavelength loop antenna and at 706 for the one-half wavelength dipole antennas combine to form a dual resonance with a bandwidth much wider than current A band antennas provide.

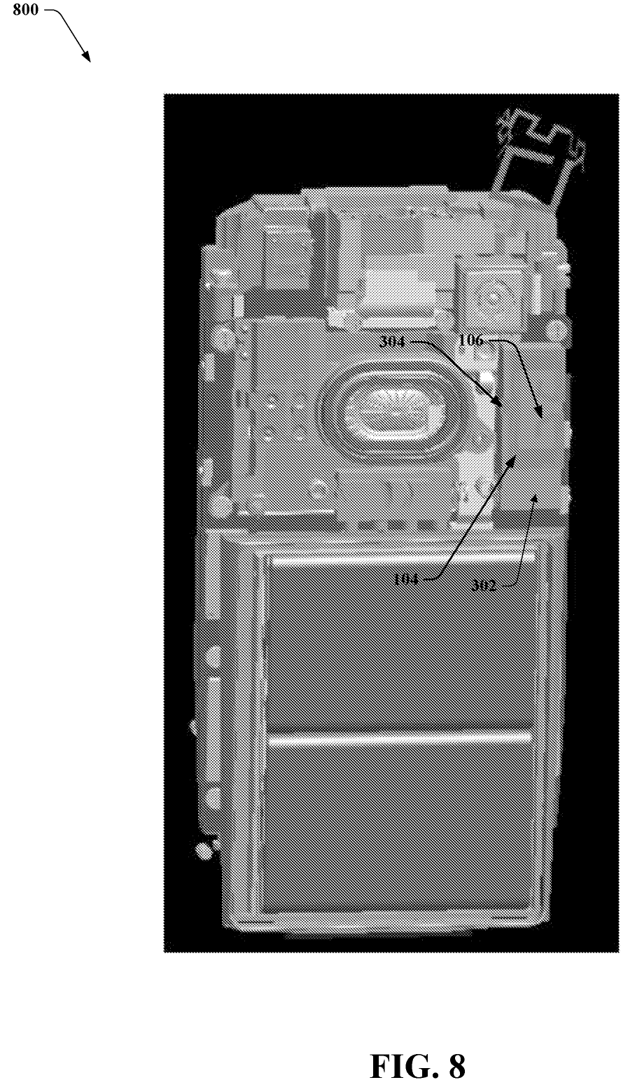

Referring now to FIG. 8, a representation of a typical mobile computing device 800 is presented. Installed on the printed circuit board of the mobile computing device 800 is a plastic mounting block 302 with the subject innovation parasitic dipole assisted WLAN antenna. The one wavelength loop antenna is depicted at 104 and the two one-quarter wavelength dipole antenna elements are depicted at 106. In another aspect of the subject innovation, the connection point of the one-quarter wavelength B/G band monopole antenna is visible at 304. It should be noted that the B/G band one-quarter wavelength is present but not visible in this depiction.

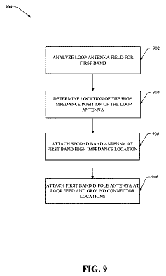

Referring next to FIG. 9, a method 900 of creating a parasitic dipole assisted WLAN antenna is depicted. At step 902, the one wavelength loop antenna is analyzed to generate a field strength mapping. This mapping is illustrated by FIG. 4 and FIG. 5. The diagram highlights areas where the field strength is at its weakest and at its strongest.

In another aspect of the subject method 900 illustrated at step 904, the location of the maximum impedance is determined for the A band one wavelength loop antenna. This location allows for the connection of another monopole antenna, such as the B/G band one-quarter wavelength monopole antenna, supporting a different frequency with an expected least interference between the two frequency bands. It should be noted that the subject innovation is not limited to the A and B/G bands of a wireless network.

In another aspect of the subject method 900 illustrated at step 906, the secondary band monopole antenna, the B/G band quarter-wavelength monopole antenna in this example, is connected to the primary band loop antenna, the A band one wavelength loop antenna, at the point of maximum impedance of the A band. Connecting the two bands at this point provides for maximum field strength of the two bands with minimal interference between the two bands.

In another aspect of the subject method 900 illustrated at step 908, the A band half wavelength dipole antennas are attached at the A band one wavelength loop antenna feed pin and ground pin respectively. These two locations are areas of maximum H field strength at the A band and allow the dipole antennas to generate additional A band resonance thus enhance one wave length loop structure resonant bandwidth and accordingly improve signal strength.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described above, methodologies that can be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Accordingly, no single embodiment shall be considered limiting, but rather the various embodiments and their equivalents should be construed consistently with the breadth, spirit and scope in accordance with the appended claims.

While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

What is claimed is:

1. A parasitic dipole assisted antenna for creating additional resonance and maximizing the usable bandwidth for a computing or communication device, the apparatus comprising:
a first band loop antenna for creating a resonance at a first band frequency;
a first band frequency dipole structure connected to the first band loop antenna for creating a second resonance at the first band frequency; and
a second band monopole antenna, connected to the first band loop antenna, for creating a resonance at a second band frequency.

2. The apparatus of claim 1, the first band comprises a wireless local area network A band.

3. The apparatus of claim 1, the second band comprises a wireless local area network B/G band.

4. The apparatus of claim 2, the A band loop antenna comprises a one wavelength loop antenna.

5. The apparatus of claim 3, the A band dipole structure comprises two one-quarter wavelength antenna elements.

6. The apparatus of claim 1, the parasitic dipole assisted antenna structure is attached to a non-conductive mounting block.

7. The apparatus of claim 6, the non-conductive mounting block is plastic.

8. The apparatus of claim 6, the non-conductive mounting block is attached to the printed circuit board of the computing or communication device.

9. The apparatus of claim 1, the second band monopole antenna is connected to the first band loop antenna at a point on the first band loop antenna where the impedance of the first band is at a maximum.

10. The apparatus of claim 1, the dipole structure is connected to the first band loop antenna as a first element connected to a feed pin and a second element connected to a ground pin.

11. The apparatus of claim 10, the attached dipole elements are within the first band loop antenna.

12. The apparatus of claim 11, the attached dipole elements are in the same plane as the first band loop antenna.

13. The apparatus of claim 9, the second band monopole antenna is attached in a plane perpendicular to the plane of first band loop antenna.

14. The apparatus of claim 3, the B/G band antenna comprises a one-quarter wavelength monopole antenna.

15. A method of creating a parasitic dipole assisted antenna for a computing device or a communication device, the method comprising:
analyzing a first band loop antenna to determine a field strength mapping;
determining the location on the first band loop antenna of maximum impedance;
attaching a second band monopole antenna at the location of the first band loop antenna maximum impedance; and
attaching a first band dipole antenna structure at the first band antenna loop feed pin and ground pin locations.

16. The method of claim 15, further comprising attaching the parasitic dipole assisted antenna to a non-conductive mounting block.

17. The method of claim 15, further comprising orienting the second band monopole antenna in a plane perpendicular to the plane of the first band loop antenna.

18. A parasitic dipole assisted antenna, the apparatus comprising:
means for creating a first resonance at a first band frequency;
means for creating a second resonance at the first band frequency; and
means for creating a resonance at a second band frequency.

19. The apparatus of claim 18, further comprising means for attaching the parasitic dipole assisted antenna to a printed circuit board.

20. The apparatus of claim 18, further comprising means for mounting means for creating the resonance at the second band frequency in a plane perpendicular to a plane for mounting means for creating the first resonance at the first band frequency.
